(19) United States
(12) Patent Application Publication
(10) Pub. No.: US 2010/0199207 A1
(43) Pub. Date: Aug. 5, 2010

(54) METHOD, DEVICE AND USER INTERFACE FOR CONTROLLING THE ACQUISITION OF MEASUREMENT DATA IN A MEDICAL IMAGING DEVICE

(76) Inventors: Andrea Hopf, Gaal (AT); Stefan Assmann, Erlangen (DE); Karlheinz Glaser-Seidnitzer, Fuerth (DE); Michaela Schmidt, Uttenreuth (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/698,287

(22) Filed: Feb. 2, 2010

(30) Foreign Application Priority Data
Feb. 2, 2009 (DE) 10 2009 007 040.0

(51) Int. Cl. G06F 3/048

(52) U.S. Cl. 715/772; 715/810

(57) ABSTRACT

In a method for controlling the recording of measurement data in a medical image acquisition device, in particular a magnetic resonance device, having a control device and an operating device having a display device for displaying a user interface that comprises a navigation area and a content area, when a step is selected in the operating sequence of the acquisition of the measurement data in the navigation area of the user interface, an item of status information of the step is determined by the control device, as a function of the item of status information, at least one status-specific item of information and/or at least one status-specific operating element is shown in the content area.

### BACKGROUND OF THE INVENTION

1. Field of the Invention

The present invention relates to a method for controlling the acquisition of measurement data in a medical image recording device, in particular a magnetic resonance device, having a control device and an operating device with display device for displaying a graphic user interface. In addition, the present invention relates to an appertaining image acquisition device, in particular a magnetic resonance device, and an appertaining user interface.

2. Description of the Prior Art

Examinations using medical image acquisition devices, in particular magnetic resonance devices, are known to be extremely complicated because a significant amount of knowledge is required. Their operation requires a long and intensive training period.

User interfaces known today have come about essentially through the expansion of basic packets. Repeatedly, functions have been added that were not planned from the beginning, due to the fact that new image recording possibilities became available. For example, although magnetic resonance data contain complete diagnostic information this image modality was used only rarely in areas such as cardiac examination. Additional dialogues or menu entries were added for this purpose that are ultimately not illuminating and not intuitive for the user. As a result, users have to be trained in order to cope with the inadequacies of the user interface. An effective, simple controlling of the image recording device is not possible.

Another problem is that of monitoring information, such as system status or information concerning the measurement in progress. In known representations on the display device of an image acquisition device, such items of information are usually shown in a small font size at the lower left edge of a display screen. These items of monitoring information are superimposed on parts of the image, and are not integrated into the user interface. The connection between the images and the individual measurement steps is difficult to understand.

Further disadvantages of known user interfaces and control methods include, for example, the situation of similar operating elements at different locations, and the usually unclear connection between operating elements and items of information that should belong together, i.e. that are associated with the same step. For example, depending on the measurement method, the measurement is started at different positions in the user interface or in a pop-up window, and items of information or operating elements that belong together are situated far away from one another in the user interface. In addition, in particular due to the above-mentioned separate positioning of items of monitoring information, in currently used user interfaces the user cannot recognize if a step still actually has to be carried out, and whether operating elements may still effectively be used to set operating parameters.

Thus, in summary, the controlling of the recording of measurement data in image recording devices, in particular magnetic resonance devices, is extremely complicated and prone to errors. In the context of the present description, the acquisition of measurement data may also include the planning of measurement steps and their basic evaluation, for example quality control.

### SUMMARY OF THE INVENTION

An object of the present invention is to provide a control method for acquiring measurement data in imaging devices that, through the production of information in real time that is adapted to the status of the image recording device, enables control of the imaging device that is less susceptible to error and is easier to understand, so that the image quality is also improved.

This object is achieved by a method for controlling acquisition of measurement data in a medical imaging device that has a control device and an operating device having a display device for displaying a graphic user interface that includes a navigation area and a content area. In accordance with the invention, when a step is selected during the operating sequence in the acquisition of measurement data in the navigation area of the user interface, an item of status information concerning the step is determined by the control device, and dependent on the status information, at least one status-specific item of information and/or at least one status-specific operating element is displayed in the content area.

The user interface that is to be displayed, that has a navigation area in which a step can be selected during the operating sequence for the acquisition of measurement data, and also includes a content area, can thus be adapted dynamically to the current state or status of the image recording device. An item of technical information, the status information, which describes the state of the image recording device at least with regard to the selected step during the operating sequence of the recording of the measurement data, is correspondingly evaluated in order to enable the selection and displaying in the user interface of particular items of status-specific information, for example including items of monitoring information and/or status-specific operating elements with which for example operating parameters, in particular recording parameters, of the image recording device can be set. On the basis of the operating parameters set via the operating elements, in particular recording parameters, the controlling of the image recording device then takes place via the control device; in other words, as a consequence the image recording device is controlled in a manner corresponding to the selection made via the at least one operating element.

Thus, the invention is a dynamic user interface matched to specific steps, in particular measurement steps, in the operating sequence of the acquisition of measurement data, the user interface being as a result configured so as to be suitable for the task at hand, and presenting the information necessary for the examination being carried out in the right place and at the right time. The method according to the present invention thus supports the user in making decisions, and the dynamic contents help guide the user through the examination. As a result, the goal of providing good images for a diagnosis quickly and without error is achieved effectively, efficiently, and satisfactorily. Ultimately, therefore, the operating sequence of the examination (or of the recording of the measurement data), as technical information, is evaluated and imaged in the user interface in a manner focused on the task at hand. Through this imaging, connections in the operating sequence can be dynamically visualized, so that ultimately a concept is described that enables the production of a user interface that is suitable for the task. The method guides the user systematically through the operating sequence. Time and mental energy can be saved because the method offers appropriate and understandable work information and tools. Thus, distracting information is removed, and overloading of the user interface is avoided.

This ultimately also results in shorter processing times and faster examinations. The user can concentrate better on the patient being examined, the work with the image recording device is simpler, and user motivation is increased because errors are avoided and the operating sequence flows better.

An item of status information can be used that assumes three values, the first value indicating that the step still has to be processed, the second value indicating that the step is currently being processed, and the third value indicating that the step has already been processed. In the context of the operating sequence, the recording of the measurement data is generally made up of a measurement protocol having a plurality of measurement steps, or also other steps, that are processed one after the other. Consequently, the user first determines a focus by selecting a step in the navigation area, for example from a working list. Depending on the value of the item of status information (step accomplished/measured, step currently being accomplished/measured, step still has to be accomplished/measured), relevant items of information and operating elements are displayed.

For a measurement step that is still to be processed, at least one item of planning information, in particular at least one image that is to be used as a basis for the planning, is selected and is displayed in the content area, and/or at least one operating element used for planning is displayed in the content area. If, consequently, a measurement step is still to be planned (focus on planning), the method can be used to automatically display the image or images that the user can use in this planning. For example, the previously recorded images can be cataloged and assigned to measurement steps in the operating sequence. Consequently, for each subsequent measurement step/operating step, the image that is optimally suitable for the planning can automatically be loaded into the content area. In addition, for the planning specific operating elements can be used in order to enable operating parameters, here in particular recording parameters, to be set.

With regard to the second value, for a measurement step that is currently being processed, at least one item of information concerning the current measurement is displayed in the content area. In such a case, the focus of the user is thus on monitoring. If a measurement step is currently being measured, the method displays information about the current measurement. In particular, this is detailed information, for example the images currently being measured, a graphic representation of the measurements within a step (for example given multiple measurements with pauses), and the like. Here as well, of course, operating elements can be provided in order for example to stop the measurement or to enable modification of parameters.

Finally, with regard to the third value, for an already-processed measurement step, at least one image measured in said measurement step, and/or at least one operating element for the renewed execution of this measurement step, is displayed in the content area. Because, as is known, the control device tracks which steps have been assigned already-measured images, these images can be displayed there when the measurement step is re-selected. Of course, an image can also be allocated to a plurality of steps if it is used for example for the planning of a further step. In addition, it can be possible for an operating element to be displayed in the content area for the renewed execution of this measurement step. Thus, the user can for example view the image or images and, if their quality is inadequate, decide to carry out a so-called “rerun”; i.e. to measure the corresponding images again. However, particularly advantageously it can be provided that, on the basis of an algorithm, the measurement data of the image are evaluated with regard to their quality and a corresponding item of information, in particular a proposal for the re-execution of this measurement step, can be displayed in the content area. Consequently, a first evaluation of the recorded measurement data of the image assists the user in making the decision to carry out a rerun if warranted. Here it can be provided that the measurement data are evaluated for measurement artifacts and/or the signal-to-noise ratio (SNR) and/or the contrast-to-noise ratio. For example, in the case of magnetic resonance a search can be made for convolutions that are relatively easy to determine algorithmically. In order to derive therefrom the proposal for the renewed execution of the measurement step, i.e. a rerun, criteria, for example boundary values, can be provided upon whose fulfillment the corresponding item of information is displayed. Thus, it is possible to re-measure the images if they do not meet the desired level of quality.

In a further embodiment of the method according to the present invention, the item of status information is determined continuously, and, given a change in the status, the item of information specific to the new status and/or the operating element specific to the new status is displayed, in particular after confirmation by a user. In this case, the technical information is thus permanently tracked via the state of the image recording device, so that for example after the conclusion of a measurement step the displayed items of monitoring information can be replaced, after confirmation by the user if warranted, by a display of the measured images and first evaluation options. Thus, a constant monitoring takes place that enables a real-time adaptation of the user interface.

Various values of the status information can be assigned a color and/or a type of emphasis, and steps displayed in the navigation area can be colored depending on the value of their status information. In this case, as a result the status of each step is continuously monitored; that is, the associated status information is queried and the configuration of the user interface is correspondingly adapted. For example, already processed/measured steps can be displayed in gray, steps currently being measured and steps still to be measured can be colored green, and the currently selected step can be shown in brown. This makes the display intuitive and easy to survey, and the user is given additional information concerning the progress of the operating sequence. In order to further increase the intuitiveness and information content of the user interface, it can additionally be provided that all displayed items of information and/or operating elements that can be allocated to a step are shown in the color corresponding to the status information of that step.

For the selection of the steps, in the navigation area an operating of selectable steps can be displayed in a selection sub-area. In the form of such an operating list, an easy and convenient selection of steps of the operating sequence is possible.

The navigation area can have a status sub-area in which current items of monitoring information are displayed relating to the recording of the measurement data and/or the image recording device, and/or a physiology sub-area in which current physiological data of a patient to be examined, in particular the EKG, are displayed. If items of monitoring information are displayed, the user then always has visual access to the status of the measurement data recording/image recording device. In this way, it is always possible to intervene in the measurement as needed. For example, as items of monitoring information status bars and a countdown, the countdown of pauses, general items of system information (system adjusting, measurement stopped, system waiting for user input, automatic respiratory commands, . . . ), and the like can be displayed. At the same time, if a physiology sub-area is provided, it is also possible to constantly keep an eye on the relevant data of a patient, for example his EKG or the like, in order to enable intervention in case of emergency. In this way, optimal information increases the user's overview.

The content area can include an image sub-area, in which images are displayed that are assigned to the selected step, and/or a setting sub-area in which monitoring information and/or at least one operating element are displayed. Thus, as already described, the content area contains general items of information relating to the selected operating step. Concretely, for example, in an upper sub-area images can be displayed that are being used to work, or that are relevant for the selected step, it being determined, as described, which images are assigned to which steps. However, the user can also be given the possibility of loading different images at any time in order for example to use them for planning. In a further sub-area, items of information and setting possibilities concerning the selected step can be provided.

In a further embodiment of the present invention, the user interface can include, in addition to the navigation area and the content area, a storage area in which selection elements, in particular thumbnails and/or folders of various categories of images, can be displayed for the user-defined selection of already-recorded images. Here, thumbnails are small versions of the actual image, provided if warranted with text elements for identification. In the method, it can be provided that measured images are automatically assigned to particular image categories. Such folders are frequently also referred to as segments. For example, the images can be automatically sorted according to their orientation. Thus, for example in the case of cardiac examinations, it can be provided that as folders “minor axis,” “two-chamber view,” “three-chamber view,” “four-chamber view,” and “localizer,” as well as “other” if warranted, can be provided.

Usefully, the storage area can comprise a folder sub-area, in which the folders, in particular provided with icons, can be selected, and a thumbnail sub-area in which the images of a selected folder can be selected. The folders in the folder sub-area can in particular be provided with icons that for example reproduce the orientation in a quickly surveyable manner.

If no folders are provided, it can also be provided that in the storage area only the images assigned to the selected step can be displayed and/or selected.

For a more intuitive apprehension of the connections preferably provided that images shown in a storage area and assigned to a step are shown in the color corresponding to the status of the step, or at least one image currently displayed in the content area is displayed with emphasis in the storage area. In this way, the connections can be surveyed even more easily, and the accessibility of the user interface is further increased.

In order to enable an adaptation by the user of the user interface, wherein the various areas comprise sub-areas, the sub-areas of an area can be adapted in their size and situation by a user. In this way, a user can optimally configure the areas—navigation area, content area, and, if warranted, storage area—according to his personal requirements. A wide variety of possibilities is conceivable here; for example, items of monitoring information and items of physiological information can be displayed above an operating list, or a decision can be made as to whether and how many images are displayed in the content area.

A further possibility for adaptation is provided if the navigation area, the content area, and, if warranted, the storage area are displayed as columns. Such a column representation enables a particularly simple and easily surveyable structuring of the user interface. In particular, it can then be provided that the width of the columns can be adjusted by a user.

In a further embodiment of the method according to the present invention, the user interface images the operating sequence of the recording of the measurement data in the direction of reading, i.e. from left to right and/or from top to bottom. For example, it can be provided that the navigation area, fashioned as a column, the content area, fashioned as a column, and, if warranted, the storage area, fashioned as a column, succeed one another from left to right. This provides additional intuitiveness and simplicity of the controlling. In addition, it can usefully be provided that, in particular at the upper edge of the user interface, a bar can be provided that displays various sub-processes of the operating sequence, each including a number of steps, the current sub-process, in particular the preparation or execution of the recording of the measurement data, being displayed with emphasis. Such a bar thus guides the user through the operating sequence. In addition to the possibilities already named, sub-processes can include “prepare examination” and “carry out examination,” as well as “register patient” or “evaluate images.”

In addition to the method, the present invention also relates to an image acquisition device, in particular a magnetic resonance device, having a control device and an operating device fashioned for the execution of the method according to the present invention. All embodiments relating to the method carry over to the image recording device. In such an image acquisition device, via the control device, the status of the image recording device, in particular of a selected step, is able to be determined, which is expressed as a dynamic adaptation of a user interface that is to be displayed on a display device of the operating device. In this way, the current state of the image recording device is thus converted into a user guide oriented to the operating sequence, enabling a user interface suitable to the task at hand. The user is systematically guided through the operating sequence, making it possible to save time and mental energy, remove distracting information, and thus to realize a faster examination that avoids error.

The present invention also relates to a user interface for display on a display device of an operating device of an image acquisition device, the interface having a navigation area and a content area, such that after determination of an item of status information concerning a step upon selection of the step in the operating sequence of the measurement data recording in the navigation area of the user interface, at least one status-specific item of information and/or at least one status-specific operating element can be displayed in the content area as a function of the status information. The advantages described above are also achieved by the user interface according to the present invention.

### BRIEF DESCRIPTION OF THE DRAWINGS

FIG. 1 shows a sequence plan of the method according to the present invention.

FIG. 2 shows the subdivision of an examination using a medical image acquisition device.

FIG. 3 shows the structure of the user interface according to the present invention.

FIG. 4 shows an exemplary design of the navigation area.

FIG. 5 shows a number of possible layouts of the content area.

FIG. 6 shows a number of possible layouts of the storage area.

FIGS. 7-9 show views of the user interface according to the present invention for various values of the status information.

FIG. 10 shows an image acquisition device according to the present invention.

### DESCRIPTION OF THE PREFERRED EMBODIMENTS

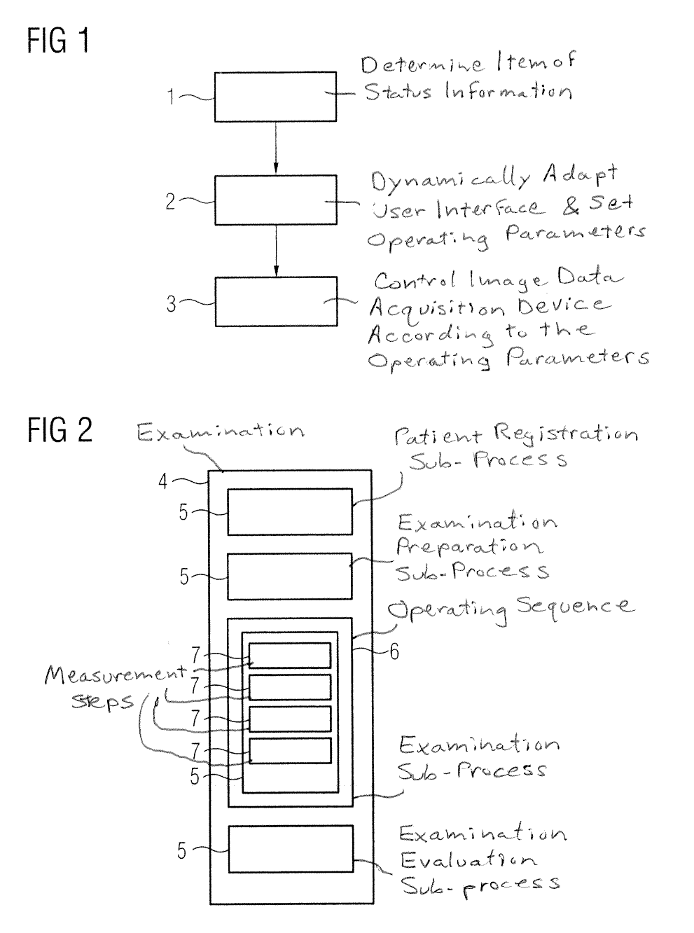

FIG. 1 shows the basic steps in the execution of the method according to the present invention. First, in a step 1, an item of status information is continuously determined for all steps of the measurement data recording that is currently to be carried out by a control device of a medical image recording device according to the present invention. The item of status information can take on three different values. A first value indicates that the step still has to be processed, a second value indicates that the step is currently being processed, and a third value indicates that the step has already been processed.

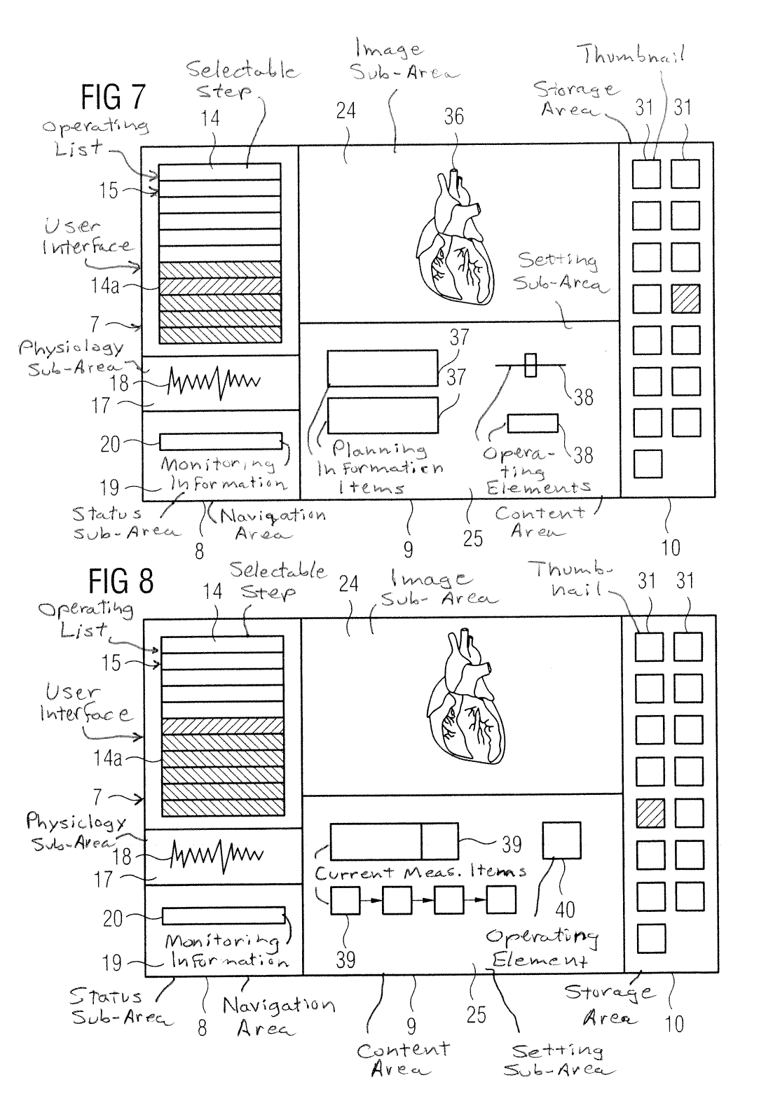

As a function of the item of status information, in a second step 2 a user interface (described in more detail below) displayed on a display device of an operating device of the image recording device is then dynamically adapted. This essentially takes place in two ways. First, the item of status information of a step selected in the user interface is used to display, in a content area of the user interface, status-specific items of information and status-specific operating elements, which is to be explained in more detail in particular in relation to FIGS. 7-9. Next, the steps shown in an operating list in a navigation area of the user interface are colored according to the value of their item of status information. Here, steps that have already been processed are colored gray, while steps that still have to be processed, as well as steps currently being processed, are colored green. Of course, the step currently being processed can be given a third color. In addition, all displayed items of information and/or operating elements that can be assigned to a step are shown in the color corresponding to the value of the status information of the step.

Moreover, the currently selected step is also assigned a color; in the present exemplary embodiment, this color is brown.

In step 2, via the user interface a user can then use the operating elements to set operating parameters, in particular recording parameters. Of course, an immediate controlling of the image recording device is also conceivable.

The actual controlling takes place in a step 3 of the method according to the present invention; that is, the image data acquisition device is controlled corresponding to the selection made via the operating elements of the user interface.

Thus, through the determination of the status information it is possible to display at all times to a user the currently required up-to-date information and operating elements specific to this status.

FIG. 2 shows, in the form of a sketch, the subdivision of an examination 4 and the nomenclature as used with regard to the further Figures. An examination 4 of a patient can first be divided into various sub-processes 5. These are, in the present case from top to bottom, the registration of the patient, the preparation of the examination, the carrying out of the examination, and, finally, the evaluation of the examination. The implementation of the examination, i.e. the acquisition of the measurement data, is the aspect with which the present invention is mainly concerned. In the present exemplary embodiment, it takes place on the basis of a measurement protocol, i.e. an operating sequence 6 that is composed of a number of measurement steps 7 that are executed one after the other. Of course, in general other steps can also be provided that relate, for example, to connected devices or the like.

In the method according to the present invention, each measurement step 7 is now assigned at each point in time an item of status information that, as described above, can assume three values depending on whether the step has already been processed, is currently being processed, or still has to be processed. The basic sequence of an examination 4 shown in FIG. 2, in particular the recording of the measurement data, is now to be shown in the design of the user interface according to the present invention.

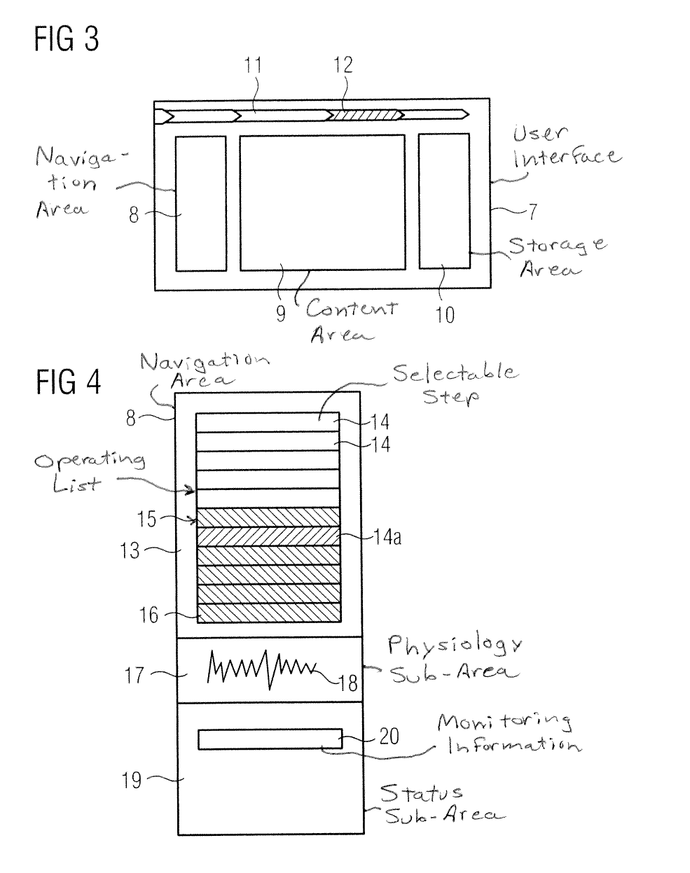

FIG. 3 shows the basic design of a user interface 7 according to the present invention. As can be seen, user interface 7 has three different areas fashioned as columns, namely a navigation area 8, a content area 9, and a storage area 10. In order to image the operating sequence of the recording of the measurement data in the direction of reading, i.e. from left to right, these areas are arranged in such a way that navigation area 8, content area 9, and storage area 10 succeed one another from the left to the right, as is shown in FIG. 3.

In order to enable further orientation to be given to a user regarding the examination sequence, user interface 7 additionally has a bar 11 situated on the upper edge of user interface 7, the bar displaying sub-processes 5 and indicating the sub-process currently being carried out, here the execution of the examination/measurement data recording, with display emphasis, as shown by hatching 12.

In order to enable user interface 7 to be adapted individually or to different diagnostic situations, the widths of the columns, i.e. of navigation area 8, content area 9, and storage area 10, can be adapted by the user.

FIG. 4 shows a possible design of navigation area 8. It includes a selection sub-area 13 in which an operating list 15 is displayed that includes selectable steps 14. Here, a user can select a step 14 that is then displayed with emphasis, for example with a particular color, as is indicated in step 14a. In addition, hatching 16 indicates that the corresponding steps have not yet been processed, or are currently being processed; i.e., in an actual display, as described above, they are shown in green. Already-processed steps are shown in gray.

Navigation area 8 further comprises a physiology sub-area 17 in which, in the present case, an EKG 18 of the patient to be examined is shown.

Finally, a status sub-area 19 is also provided in which various items of monitoring information 20 are shown that provide information concerning the state of the image recording device or of the measurement data recording. For example, here status bars, countdowns, currently measured images, general system information (system adjusting, measurement stopped, system waiting for user input, automatic respiratory commands, . . . ) and the like are shown.

The user thus always has visual access to items of monitoring information 20, the physiological data, and operating list 15.

FIG. 5 shows variants 21, 22, and 23 of the design of content area 9. In first variant 21, the content area has two image sub-areas 24 in which images assigned to selected step 14a can be displayed, and a setting sub-area 25 in which items of monitoring information, other status-specific information, and operating elements can be shown. As described above, the content of content area 9 is primarily determined by the status information; i.e., status-specific images, information, and operating elements are displayed.

In variant 22, three smaller image sub-areas 24 are provided above a larger setting area 25, while in variant 23 a single large image sub-area 24 is provided having a somewhat smaller setting area 25.

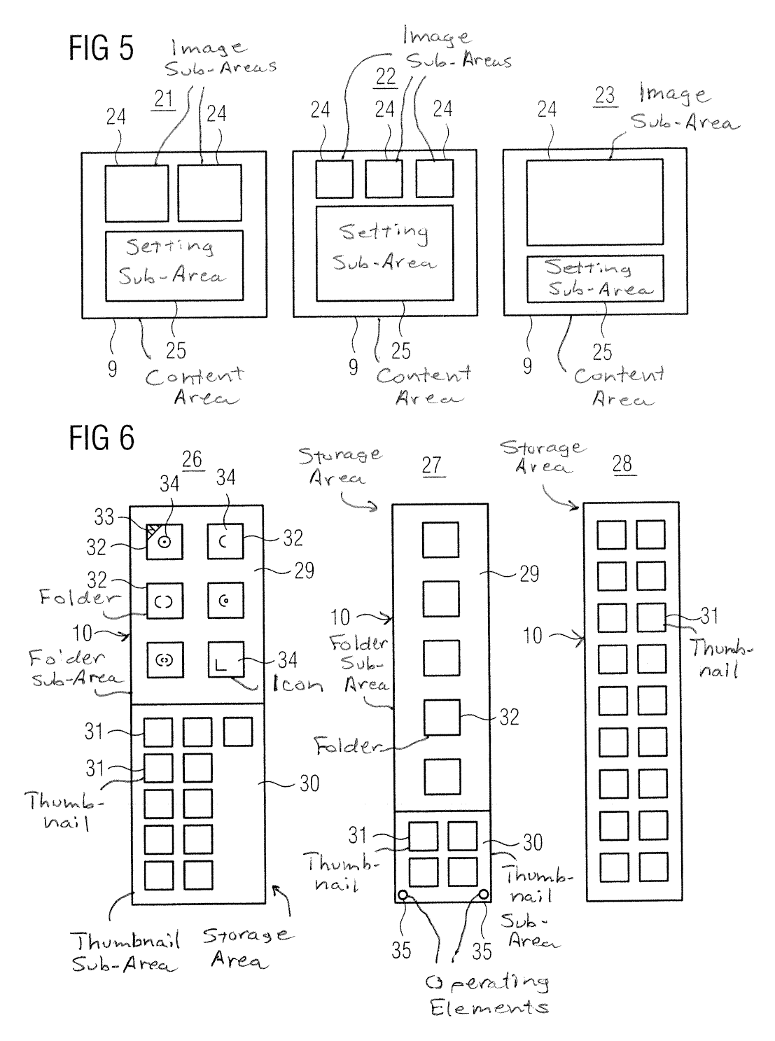

FIG. 6 shows variants 26, 27, and 28 of the design of storage area 10. In storage area 10 (“output”), selection elements are displayed for the user-defined selection of already-recorded images. The already-recorded images are first sorted by the system into various folders or segments that for example can reproduce their orientation. In addition, they are automatically assigned to one or more measurement steps, for example to the measurement step in which they were recorded or to a measurement step in which they can be used as planning images. Images assigned to selected step 14a are also shown in the color brown; of course, it can also be provided that in storage area 10 only images assigned in selected step 14a are displayed. In addition, an image currently displayed in an image sub-area 24 is shown with emphasis, for example with a thick border or in false colors.

In variant 26, the storage area has a folder sub-area 29 and a thumbnail sub-area 30 in which images are displayed of a selected folder 32 as miniature preview versions, i.e. thumbnails 31, and can be selected. Currently selected folder 32 is likewise identified to the user by an emphasis. Furthermore, icons 34 can be provided on the representations of folders 32, enabling easy identification of the folder.

In variant 27, in which storage area 10 is made narrower, a larger folder sub-area 29, and only one small image sub-area 30, is provided. Of course, operating elements 35 can also be present via which, in case it is not possible to show all thumbnails 31, further thumbnails 31 can be brought to display.

Variant 28 shows a version in which only thumbnails 31 are displayed.

Here, it is to be noted that the design of the various areas, i.e. of navigation area 8, content area 9, and storage area 10, can be adapted by a user. For example, the arrangement of various sub-areas can be modified, their size can be adjusted, and if warranted some sub-areas may even be completely omitted. Thus, a user can, on his own initiative, alternate between the depicted variants 21, 22, 23 or 26, 27, 28, or can create his own settings.

As already mentioned, the content of content area 9 depends essentially on the value of the item of status information of selected step 14a. FIGS. 7-9 show possible representations of user interface 7 for various values of the item of status information. Here, the reference characters for the areas (not discussed in further detail) navigation area 8 and storage area 10 correspond to those used in FIGS. 3-6.

FIG. 7 shows a representation in which the selected step 14a still has to be processed, so that the focus is on planning. As can be seen, in image sub-area 24 of content area 9 an image 36 is displayed that is used for the planning of selected step 14, for example in order to determine the field of view or for slice planning. Image 36 can for example be a localizer that was recorded in a previous processed step 14. In the setting sub-area, various planning-specific items of information 37 and operating elements 38 are displayed via which operating parameters, in particular recording parameters, can be set, or commands can be given to the image recording device. It is to be noted that, parallel to the currently selected step 14a, items of monitoring information 20 concerning the current measurement are at all times shown in status sub-area 19. Simultaneously, EKG 18 can be tracked in physiology sub-area 17.

FIG. 8 shows a possible representation of user interface 7 during the processing of selected step 14a. Image sub-area 24 of content area 9 acts here as a live display; i.e., the image currently being recorded is displayed. In setting sub-area 25, items of information 39 are shown concerning the current measurement, for example progress bars or a graphic representation of the measurements. In addition, an operating element 40 for stopping the measurement is also for example situated there.

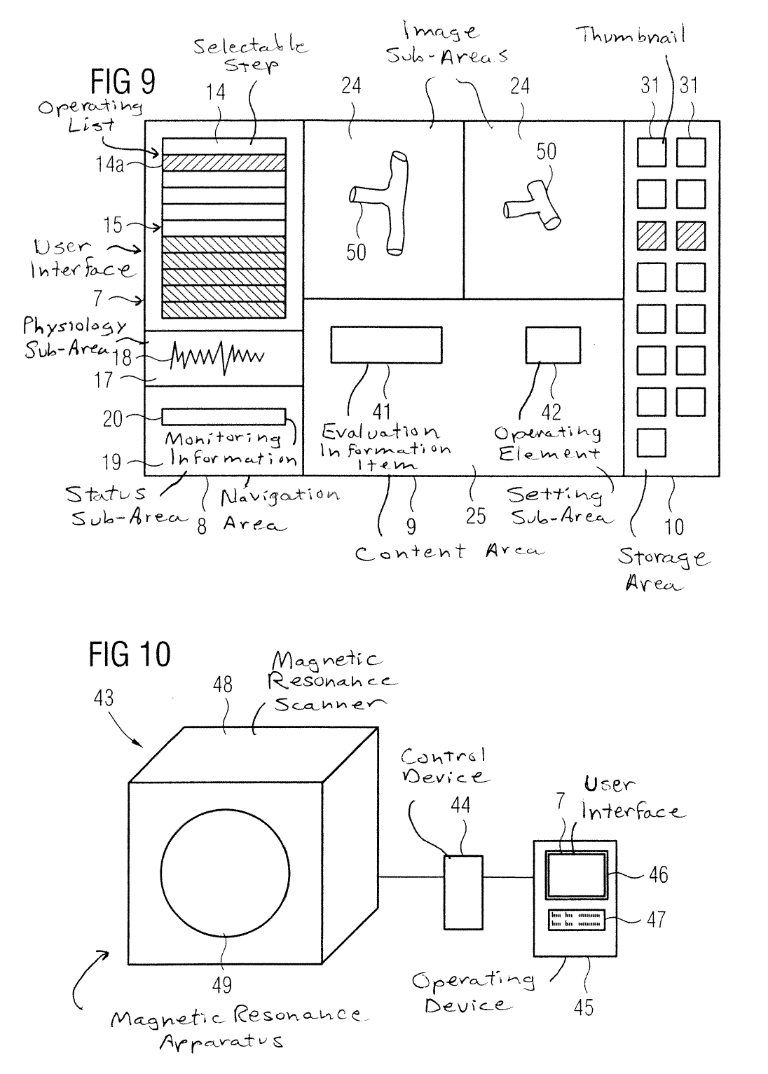

FIG. 9 shows a possible representation of user interface 7 in a situation in which selected step 14a has already been processed. Images 50 recorded in this step 14a are shown in two image sub-areas 24. In setting sub-area 25, in addition to options for preparatory evaluation there is situated an item of information 41 concerning the quality of the images and an operating element 42 with which a new measurement of step 14a (rerun) can be triggered. Items of information 41 were here determined in the context of the method according to the present invention by evaluation of the measurement data using an algorithm. Here, the measurement data of images 50 were evaluated with regard to measurement artifacts, the signal-to-noise ratio, and the contrast-to-noise ratio. In this way, the user is supported in quality control.

FIG. 10 is a schematic illustration of an image data acquisition device according to the present invention, fashioned here as a magnetic resonance apparatus 43. It has, in a known manner, a scanner 48 having a patient receptacle 49; the corresponding technologies are widely known and are not presented here in more detail. In addition, image recording device 43 has a control device 44 as well as an operating device 45 having a display device 46 on which user interface 7 can be displayed, and an input device 47 for making inputs. Here, the image acquisition device 43 is fashioned for the execution of the method described in the present application.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for controlling acquisition of measurement data in a medical imaging device, comprising the steps of:
at a display device of a control device that operates a medical image data acquisition device, displaying a user interface comprising a navigation area and a content area;
in said navigation area of said user interface, displaying an operating sequence, comprising a plurality of operating sequence steps, for operating said medical data image acquisition device by said control unit;
via said user interface, selecting an operating sequence step from among the plurality of operating sequence steps displayed in said navigation area;
in response to the selection of said one of said operating sequence steps, automatically determining, in said control device, an item of status information associated with said one of said operating sequence steps; and
dependent on said item of status information, causing, from said control unit, display of at least one content area item in said content area of said user interface, selected from the group consisting of at least one item of status-specific information and at least one status-specific operating element.

2. A method as claimed in claim 1 comprising, in said control unit, giving said item of status information a value from among a first value indicating that said one of said operating sequence steps still must be executed in said operating sequence, a second value indicating that said one of said operating sequence steps is currently being executed in said operating sequence, and a third value indicating that said one of said operating steps has already been executed in said operating sequence.

3. A method as claimed in claim 2 wherein, when said control unit assigns said first value to said item of status information, also generating in said control unit, and displaying in said content area of said user interface, at least one of an item information and an operating element for implementing a planning item.

4. A method as claimed in claim 2 comprising, when said control unit assigns said second value to said item of status information, also generating in said control unit, and displaying in said content area, at least one item of information describing current execution of said operating sequence.

5. A method as claimed in claim 2 comprising, when said control unit assigns said third value to said item of status information, also generating in said control unit, and displaying in said content area, at least one an image acquired by said one of said operating sequence steps and an operating element for repeated execution of said at least one of said operating steps.

6. A method as claimed in claim 5 comprising, before displaying said image, analyzing, in said control unit, a quality of measurement data comprising said image and, if said quality is below a predetermined quality level, displaying said operating element for repeated execution of said one of said operating steps.

7. A method as claimed in claim 6 comprising evaluating said quality of said measurement data in said control unit with respect to at least one quality characteristic selected from the group consisting of presence of artifacts, signal-to-noise ratio, and contrast-to-noise ratio.

8. A method as claimed in claim 1 comprising, in said control unit, continuously determining said item of status information and, when said item of status information indicates a status change, displaying a different item of status information, indicating the changed status, in said content area.

9. A method as claimed in claim 1 wherein said item of status information is assigned a plurality of different values by said control unit and wherein said control unit assigns a different color to each of said different values and displays said item of status information in said content area with the color respectively associated with the value of said item of status information.

10. A method as claimed in claim 9 comprising displaying all information in said content area associated with said item of information with the color respectively corresponding to the value of said item of status information.

11. A method as claimed in claim 1 comprising displaying said list of operating steps in a designated selection sub-area of said navigation area.

12. A method as claimed in claim 11 comprising also displaying in said navigation area a sub-area in which a plurality of items of current monitoring information describing at least one of current acquisition of measurement data and current operation of said image data acquisition device are displayed.

13. A method as claimed in claim 11 comprising also displaying in said navigation area a physiology sub-area in which current physiological data of a patient, from whom said image data are being acquired, are displayed.

14. A method as claimed in claim 1 comprising also displaying in said content area an image sub-area in which images associated with said one of said operating steps are displayed.

15. A method as claimed in claim 1 comprising also displaying in said content area a setting sub-area in which at least one of items of monitoring information and at least one operating element are displayed.

16. A method as claimed in claim 1 comprising displaying in said user interface a storage area in which selection elements are displayed for user-defined selection of previously-acquired images.

17. A method as claimed in claim 16 comprising displaying, in said storage area, a folder sub-area in which icon-identified folders are displayed for said respective images.

18. A method as claimed in claim 14 comprising, in said storage area, displaying only images associated with said one of said steps of said operating sequence.

19. A method as claimed in claim 16 comprising assigning said item of status information a value, from among a plurality of values, in said control unit, each of said values in said plurality of values having a color uniquely associated therewith, and displaying said images in said storage sub-area with the color corresponding to the value of said item of status information.

20. A method as claimed in claim 14 comprising providing a setting element at said user interface allowing a user to select a size of each of said navigation area, said content area and said image sub-area.

21. A method as claimed in claim 20 comprising displaying each of said navigation area, said content area and said sub-area as columns, each having a width, and changing said size of said navigation area, said content area and said sub-area by changing the respective width thereof.

22. A method as claimed in claim 1 comprising displaying an operating element at said user interface allowing a user to select a direction of reading of information displayed at said user interface from directions of reading selected from the group consisting of left to right and top to bottom.

23. A method as claimed in claim 22 comprising displaying said navigation area and said content area as columns.

24. A method as claimed in claim 23 comprising displaying a bar at an upper edge of said user interface comprising indicators for sub-processes of said operating sequence.

25. A method as claimed in claim 1 comprising providing a setting element at said user interface allowing a user to select a size of each of said navigation area and said content area.

26. An image data acquisition system comprising:
a medical image data acquisition device;
a control device that operates said medical image data acquisition device;
a display device in communication with said control device;
said control device being configured to display, at said display device, a user interface comprising a navigation area and a content area;
said control device being configured to display, in said navigation area of said user interface, an operating sequence, comprising a plurality of operating sequence steps, for operating said medical data image acquisition device by said control unit;
said user interface being configured to allow manual selection of an operating sequence step from among the plurality of operating sequence steps displayed in said navigation area;
said control device being configured, in response to the selection of said one of said operating sequence steps, to automatically determine an item of status information associated with said one of said operating sequence steps; and
said control device being configured, dependent on said item of status information, to cause display in said content area of at least one content area item, selected from the group consisting of at least one item of status-specific information and at least one status-specific operating element.

27. A user interface for operating an image data acquisition device comprising:
a display device and a control device that operates a medical image data acquisition device, said control device being configured to display a graphical user interface presentation, at said display device, comprising a navigation area and a content area;
said control device being configured to display, in said navigation area of said graphical user interface presentation, an operating sequence, comprising a plurality of operating sequence steps, for operating said medical data image acquisition device by said control unit;
said graphical user interface presentation being configured to allow manual selection of an operating sequence step from among the plurality of operating sequence steps displayed in said navigation area;
said control device being configured, in response to the selection of said one of said operating sequence steps, to automatically determine an item of status information associated with said one of said operating sequence steps; and
said control device being configured, dependent on said item of status information, to cause display in said content area of at least one content area item, selected from the group consisting of at least one item of status-specific information and at least one status-specific operating element.
